(19) United States
(12) Patent Application Publication
(10) Pub. No.: US 2017/0318986 A1
(43) Pub. Date: Nov. 9, 2017

(54) Merchandise Display Strip

(71) Applicant: American Greetings Corporation, Cleveland, OH (US)

(72) Inventor: Anthony Santarelli, North Olmsted, OH (US)

(21) Appl. No.: 15/147,967

(22) Filed: May 6, 2016

(51) Int. Cl. A47F 5/00; F16B 1/00; F16M 13/02

(52) U.S. Cl. CPC A47F 5/0006; F16B 1/00; F16M 13/022; A47F 2005/0012; F16B 2001/0035

(57) ABSTRACT

A merchandise display strip having a metal strip with a plurality of stamped apertures contained thereon for the removable insertion of a plurality of hooks for displaying merchandise suspended therefrom. The strip additionally contains one or more magnetic discs which enable the strip to be attached to various metal surfaces. The merchandise display strip can easily be moved from a vertical position to a horizontal position while simply changing the orientation of the hooks with respect to the strip.

### RELATED APPLICATIONS

There are no applications related to this application.

### FIELD OF THE INVENTION

This invention is in the field of retail display assemblies, and more specifically, to a magnetic strip with hooks which can be positioned either horizontally or vertically.

### BACKGROUND OF THE INVENTION

In today's market, retail floor space is at a premium. Product vendors try to display and sell as much merchandise as possible and must be increasingly creative in the marketing and display of products such that they maximize the amount of merchandise displayed while minimizing the amount of space required for the display of said merchandise. Space requirements and aisle configurations often differ considerably not only among retailers but also among departments within each retailer. Vendors and retailers must also be concerned with the neatness of product displays.

There currently exists support fixtures which are operable to attach onto existing display equipment to support somewhat small items such as gift cards, or small items with backing that can be suspended from various hooks or clips. Some of these supports, such as those described in U.S. Pat. Nos. 5,957,422 and 7,219,459, can support only lightweight merchandise. Heavy duty hangers, such as those described in U.S. Pat. No. 5,346,166 are not easily or quickly removed and relocated. Also, none of the prior art discloses a flexible display strip which can be vertically or horizontally oriented.

There is a need for a merchandise strip having sufficient strength to hold heavier items while also being flexible enough to attach to a variety of existing displays or surfaces and which can be oriented based on space and display configuration.

### SUMMARY OF THE INVENTION

In one embodiment, a merchandise display strip contains a strip having a plurality of apertures contained thereon, a plurality of hooks which are removably inserted into a subset of the plurality of apertures contained on the strip, one or more magnets attached to the strip for attachment of the strip to metal surfaces. The strip may be horizontally or vertically oriented.

In another embodiment a merchandise display strip includes a metal strip having a plurality of vertically oriented apertures and a plurality of horizontally oriented apertures contained thereon, a plurality of hooks which are operable to be inserted into either the plurality of vertically oriented apertures or the plurality of horizontally oriented apertures, and one or more magnetic discs which are used to attach the metal strip to other metal surfaces. The metal strip can be vertically oriented with the plurality of hooks inserted into the horizontally oriented apertures or horizontally oriented with the plurality of hooks inserted into the vertically oriented apertures.

And in still another embodiment, a merchandise display strip including a strip having a plurality of apertures contained thereon, a plurality of hooks for insertion into a subset of the plurality of apertures, and at least one magnetic disc attached to the strip. The strip may be vertically oriented or horizontally oriented.

### DESCRIPTION OF THE DRAWINGS

FIG. 1 is a perspective view of the Merchandise Display Strip of the present invention (with product suspended therefrom), in a horizontal configuration.

FIG. 2 is a cross-sectional view of the hook portion of the Merchandise Display Strip.

FIG. 3 is a perspective view of the hook portion of the Merchandise Display Strip of FIG. 1.

FIG. 4 is a side view of the hook portion of the Merchandise Display Strip of FIG. 1.

FIG. 5 is a perspective view of the Merchandise Display Strip in a vertical configuration.

FIG. 6 is a perspective view of the front surface of the strip,

FIG. 7 is a perspective view of the rear surface of the strip.

### DETAILED DESCRIPTION OF PREFERRED AND ALTERNATE EMBODIMENTS

The merchandise display strip 100 of the present disclosure and related inventions includes a strip 10 having a plurality of stamped holes therein for the removable insertion of a plurality of display hooks H for hanging product P therefrom. The merchandise display strip 100 also includes one or more magnetic discs M fastened thereto for the removable attachment of the merchandise display strip 100 to various metal surfaces S, and one or more sign grippers G for holding signage therein. The merchandise display strip 100 can be positioned vertically or horizontally depending on the space available or the configuration of the surface S to which it is to be attached. The merchandise display strip 100 allows for extreme flexibility as it can be easily moved from one location to the next and it provides a space for displaying merchandise in areas where it would not typically reside. For example, the merchandise display strip 100 may be attached to the front, side or any other metal surface which surrounds or is adjacent to a bicycle display rack and may display bicycle bags for wrapping or concealing bicycles given as gifts for birthdays, Christmas or other special occasion. The display strip takes advantage of unutilized space while providing for potential sales of merchandise outside of its normal retail space or for the display and sale of seasonal merchandise.

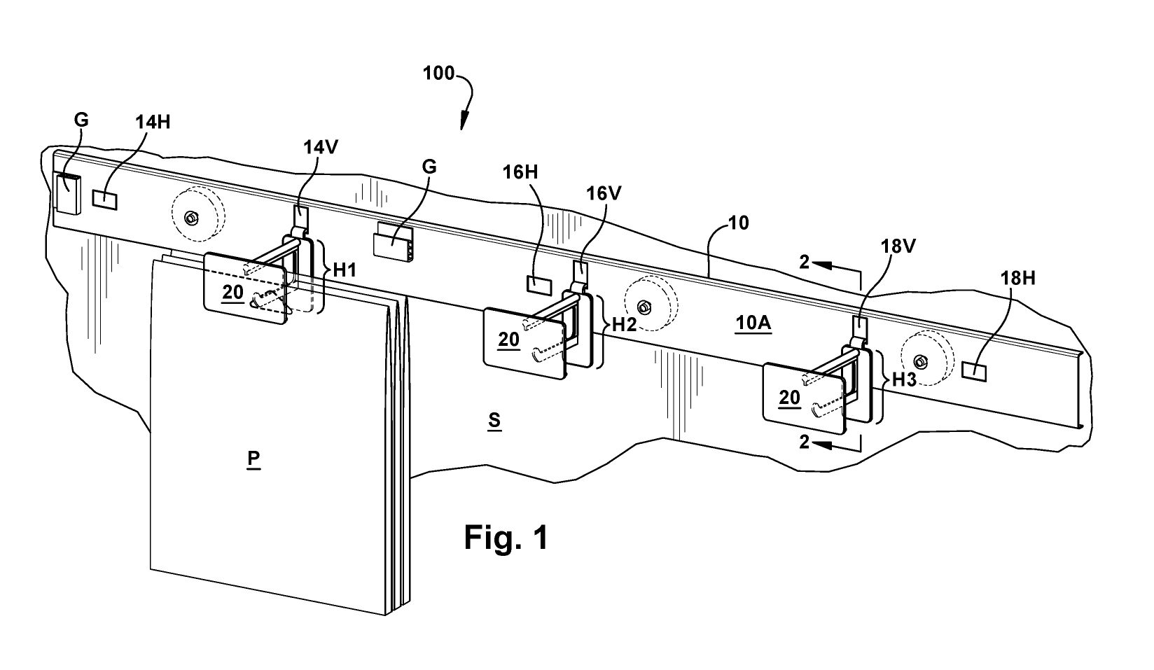

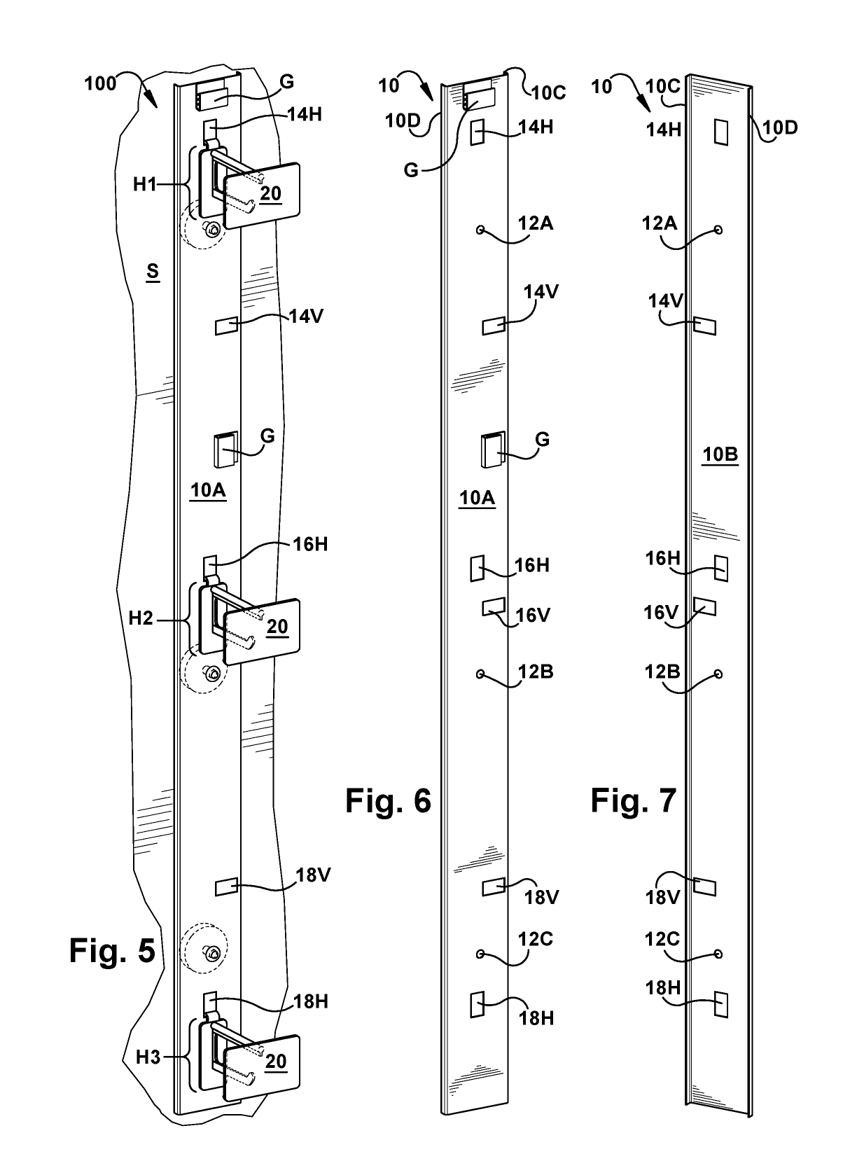

The metal strip 10 is substantially rectangular having front surface 10A and a rear surface 10B opposite the front surface 10A, as shown in FIGS. 6 and 7. The front surface 10A, shown in FIG. 6, is relatively flat having rounded or curved edges 10C, 10D which extend outward slightly from the flat rear surface 10B, shown in FIG. 7. The edges 10C, 10D form the sides of a channel on the back surface 10B of the strip 10. In a preferred embodiment, the edges 10C,10D of the channel are approximately 0.250 inches high. Also in the preferred embodiment, the metal strip 10 contains nine openings or apertures therethrough. Three of the nine apertures are rounded holes 12A, 12B, 12C and are used for the attachment of three magnets M1, M2, M3 to the strip 10 for attachment of the strip 10 to other metal surfaces. A first rounded aperture 12A is located proximate to a first end of the strip 10, a second rounded aperture 12B is located proximate to the horizontal center of the strip 10 and a third rounded aperture 12C is located proximate to a second end of the strip 10, the second end being opposite the first end. The remaining six apertures are substantially rectangular in shape and are used to accommodate the removable insertion of hooks H therein. Each rectangular aperture is approximately 0.750 inches wide and approximately 0.438 inches long. A first pair of rectangular apertures 14H, 14V is located proximate to the first end of the strip 10, a second pair of rectangular apertures 16H, 16V is located proximate to the horizontal center of the strip 10 and a third pair of rectangular apertures 18H, 18V is located proximate to the second end of the strip 10. Each pair of rectangular apertures contains a first rectangular aperture 14H, 16H, 18H which is oriented horizontally and a second rectangular aperture 14V, 16V, 18V which is oriented vertically. This configuration allows the strip 10 to be positioned in a horizontal position wherein the hooks H are inserted into the vertically configured rectangular apertures 14V, 16V, 18V, as shown in FIG. 1, and a vertical position wherein the hooks H are inserted into the horizontally configured rectangular apertures 14H, 16H, 18H, as shown in FIG. 5. The strip 10 may also have a powder coating finish. In a preferred embodiment, the strip 10 is approximately 33 inches long and 2.25 inches wide, although other sizes, both longer and shorter and wider or more narrow, are possible. Also, in a preferred embodiment, there is approximately 14-inches between each adjacent pair of horizontally configured apertures (14H and 16H or 16H and 18H) and approximately 9-inches between each pair of vertically configured apertures (14V and 16V or 16V and 18V), with the measurement taken between the leftmost edges of each pair of adjacent apertures.

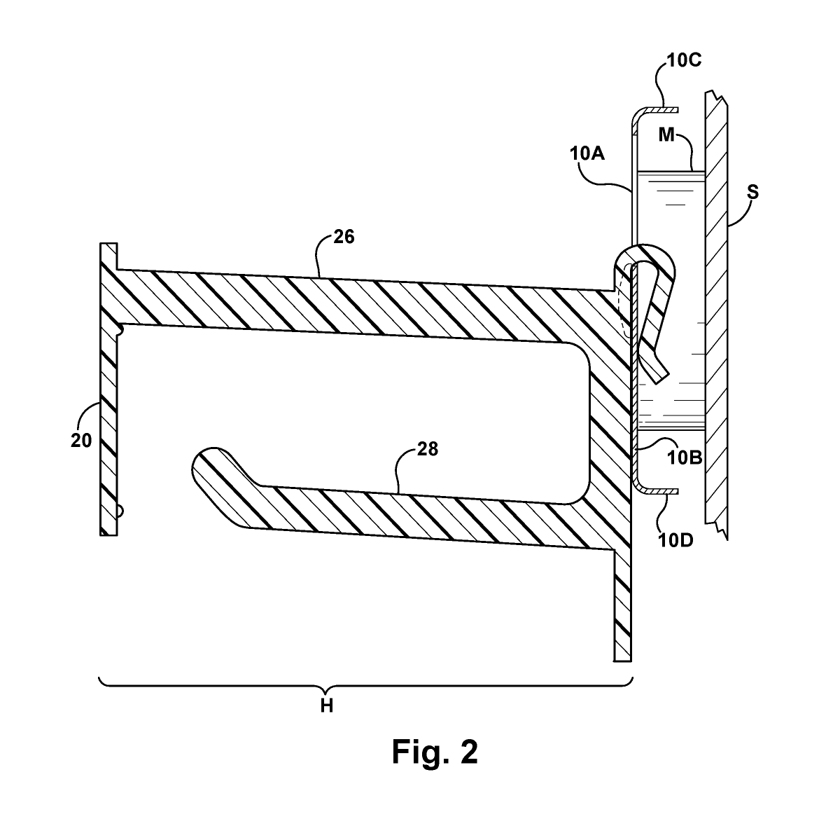

In a preferred embodiment, three magnetic discs M1, M2, M3 are attached to the strip 10 to accommodate attachment of the strip 10 to any metal surface S. Each disc M1, M2, M3 is inserted into a different one of the three rounded apertures 12A, 12B, 12C contained on the strip 10 and fastened thereto using a pop rivet, as can be seen in FIGS. 1 and 5, although other attachment or fastening means can be used. When attached, each disc M1, M2, M3 sits flush with the rear surface 10B of the strip 10, as shown in FIG. 2. In a preferred embodiment, each magnetic disc M1, M2, M3 has an approximate 1.5-inch diameter and is capable of supporting the merchandise display strip 100 with up to 30 lbs. of merchandise contained thereon. The magnetic discs M may be larger or smaller in size and fewer than three or more than three magnetic discs M may be used depending on the shape and size of the strip 10, or the weight or quantity of the product P being displayed thereon.

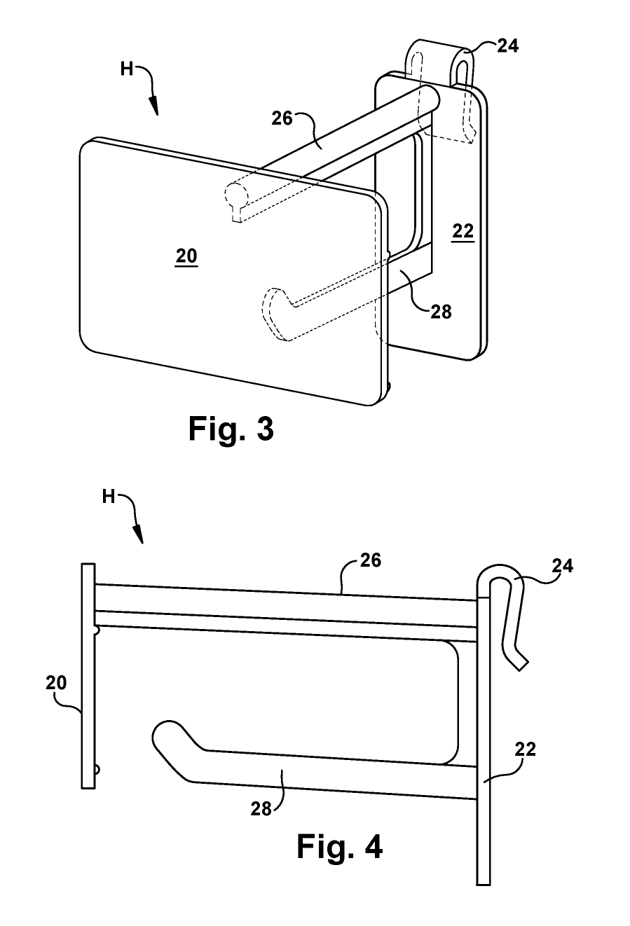

In a preferred embodiment, three hooks H1, H2, H3 can be removably attached to the strip 10 by insertion of each hook H1, H2, H3 into a different one of either the vertically 14V, 16V, 18V or horizontally 14H, 16H, 18H oriented rectangular apertures. If the strip 10 is positioned in a horizontal configuration then the hooks H1, H2, H3 are inserted into the vertically oriented rectangular apertures 14V, 16V, 18V, as shown in FIG. 1, and if the strip 10 is positioned in a vertical configuration, then the hooks H1, H2, H3 are inserted into the horizontally oriented rectangular apertures 14H, 16H, 18H, as shown in FIG. 5. In a preferred embodiment, the hooks H1, H2, H3 are scanner hooks which have mounts 20 thereon for label and sign holders allowing for the posting of product and promotional information, as shown in FIGS. 1 through 5. Each hook H1, H2, H3 contains a substantially rectangular, vertically oriented back panel 22 having a front surface and a rear surface opposite the front surface. The back panel 22 contains a curved extension 24 extending upward and outward from the top edge of thereof forming a channel between the curved extension 24 and the rear surface of the back panel 22, as shown in FIGS. 2 and 4. The back panel 22 may have a no stick or skid pad attached to the rear surface thereof to prevent the hook from tilting or sliding to one side or the other when inserted into the strip 10. Two prongs 26, 28 extend outward from and perpendicular to the front surface of the back panel 22 of the hook H. The two prongs 26, 28 are parallel to one another and are attached to the back panel 22 at the same horizontal position or at the horizontal midpoint of the back panel 22. The first prong 26 is located at a higher vertical elevation than the second prong 28. The first prong 26 has a substantially rectangular mount 20 attached to the end opposite the end which is attached to the back panel 22 of the hook H. The mount 20 is positioned perpendicular to the first 26 and second 28 prongs and parallel and spaced apart from the back panel 22 of the hook H. The rectangular mount 20 is positioned in a horizontal orientation and accommodates the attachment of a label or sign indicating product and/or promotional information. The second prong 28 which is located below the first prong 26 contains a slightly upturned end opposite the end which is attached to the back panel 22 of the hook H. The second prong 28 is shorter in length than the first prong 26 and is used to accommodate the insertion of product P thereon. The slight upturn at the end of the second prong 28 prevents the product P hanging therefrom from accidently sliding off the hook H. As mentioned above, the hooks (and strip) can support merchandise weighing up to 30 lbs. Examples of merchandise which can be displayed on or suspended from the hooks include, gift bags, invitations, note cards, stickers, candles or any other merchandise which can be suspended from a peg hook and which are under the weight threshold.

One or more sign grippers G or other type of sign holder may be attached to the strip 10, as shown in FIGS. 1 and 6. The sign grippers G are operative to hold signage flush with the strip 10 without impacting merchandising space. More sign grippers G may be used depending on the size of the strip 10 and the need for additional signage. The signage may indicate product or promotional information.

The merchandise display strip of the present disclosure and related inventions provides a flexible option for displaying merchandise on existing displays or other flat metal surfaces. It can be positioned either horizontally or vertically depending on the space available or the configuration of the surface to which it is attached. It is also flexible and convenient because it can easily be moved from one surface to another without any additional work, disassembly or reassembly. In addition to being flexible, the magnetic merchandise display strip is sufficiently strong and durable and also takes advantage of unutilized display space.

While the merchandise display strip has been described herein and shown in the figures as having specific shape, size, length and width dimensions, other shapes and sizes have been contemplated and are considered to be within the scope of the present invention. Also, while the merchandise strip has been described herein and shown in the figures as having a specific number and specific placement of apertures, the merchandise strip may have fewer or additional apertures for accommodating fewer or more hooks. The number and size of the magnetic discs may also be changed while still remaining within the scope of the invention. Also, different types of hooks may be used for displaying different types of product. And while certain types of materials have been mentioned herein, other materials have been contemplated and are considered to be within the scope of the invention.

The foregoing embodiments of the present invention have been presented for the purposes of illustration and description. These descriptions and embodiments are not intended to be exhaustive or to limit the invention to the precise form disclosed, and obviously many modifications and variations are possible in light of the above disclosure. The embodiments were chosen and described in order to best explain the principle of the invention and its practical applications to thereby enable others skilled in the art to best utilize the invention in its various embodiments and with various modifications as are suited to the particular use contemplated. It is intended that the invention be defined by the following claims.

1. A merchandise display strip comprising:
a strip having a plurality of rectangular apertures contained thereon, each of the plurality of rectangular apertures having four sides including two opposing short sides and two opposing long, and where some of the plurality of rectangular apertures are horizontally oriented and some of the plurality of rectangular apertures are vertically oriented;
the strip capable of being displayed in a horizontal or a vertical position;
the plurality of rectangular apertures being positioned in pairs which are spaced apart along the length of the strip;
a plurality of hooks which are configured to be removably inserted into one of the the plurality of rectangular apertures contained on the strip;
one or more magnets attached to the strip for attachment of the strip to metal surfaces, the one or more magnets sitting flush with and attached directly to the strip;
wherein when the strip is positioned horizontally, at least one of the plurality of hooks is inserted into one of the plurality of apertures that is vertically oriented, over one of the short sides thereof and when the strip is positioned vertically, at least one of the plurality of hooks is inserted into one of the plurality of apertures that is horizontally oriented, over one of the short sides thereof; and
wherein there is approximately 14 inches between each adjacent pair of apertures that are horizontally oriented and there is approximately 9 inches between each adjacent pair of apertures that are vertically oriented.

2. The merchandise display strip of claim 1, wherein the strip contains a rear-facing channel.

3. (canceled)

4. The merchandise display strip of claim 1, wherein each of the one or magnets is attached to the strip using a nut and bolt.

5. The merchandise display strip of claim 1 further comprising at least one sign gripper for attaching signage to the strip.

6. The merchandise display strip of claim 1, wherein the plurality of hooks are scanner hooks.

7. The merchandise display strip of claim 1, wherein the strip can display up to 30 lbs. of merchandise thereon.

8. A merchandise display strip comprising:
a metal strip having exactly three vertically oriented, rectangular apertures contained thereon and exactly three horizontally oriented, rectangular apertures contained thereon;
the three vertically and horizontally oriented, rectangular apertures arranged in three pairs along the metal strip, wherein each pair includes one vertically oriented, rectangular aperture and one horizontally oriented, rectangular aperture;
one or more magnetic discs which are used to attached the metal strip to other metal surfaces;
wherein the metal strip can be vertically oriented or horizontally oriented; and
wherein the space between the vertically oriented apertures is different from the space between the horizontally oriented apertures.

9. The merchandise display strip of claim 8, wherein the metal strip contains a rearward facing channel.

10. The merchandise display strip of claim 8, wherein the one or more magnetic discs are flush with a rear surface of the strip.

11. The merchandise display strip of claim 8, wherein there are three hooks.

12. The merchandise display strip of claim 8, wherein there are three magnetic discs.

13. The merchandise display strip of claim 8, wherein there are three vertically oriented apertures and three horizontally oriented apertures.

14. The merchandise display strip of claim 8, wherein the vertically oriented apertures are evenly spaced across the strip.

15. The merchandise display strip of claim 8, wherein the horizontally oriented apertures are evenly spaced across the strip.

16. A merchandise display strip comprising:
a strip having exactly three pair of rectangular apertures, the exactly three pair of rectangular apertures having one vertically orientated aperture and one horizontally oriented aperture;
at least one hook for insertion into one rectangular aperture of the three rectangular apertures over a short end thereof;
at least one magnetic disc attached directly to the strip;
wherein when the strip is vertically oriented, the hook is placed into the horizontally oriented aperture over one of the short ends thereof and when the strip is horizontally oriented, the hook is placed into the vertically oriented aperture over a one of the short ends thereof; and
wherein the merchandise display strip can support up to 30 lbs. of merchandise displayed thereon.

17. The merchandise display strip of claim 16, wherein the plurality of hooks are scanner hooks.

18. The merchandise display strip of claim 16, wherein the strip contains a rearward facing channel.

19. The merchandise display strip of claim 18, wherein the at least one magnetic disc is attached to a rear surface of the strip within the rearward facing channel.

20. (canceled)
